(19) United States
(12) Patent Application Publication
(10) Pub. No.: US 2008/0163798 A1
(43) Pub. Date: Jul. 10, 2008

(54) Combination Stack And Stand Table With Refuse Receptacle For Catering Or The Like

(76) Inventor: Abigail Shearer-Robinson, Dublin, NH (US)

Correspondence Address: POLLACK, P.C., THE CHRYSLER BUILDING, 132 EAST 43RD STREET, SUITE 760, NEW YORK, NY, 10017, US

(21) Appl. No.: 10/587,422

(22) PCT Filed: Jan. 26, 2005
(86) PCT No.: PCT/US05/03085

§ 371 Date: Oct. 9, 2007

Related U.S. Application Data
(60) Provisional application No. 60/539,492, filed on Jan. 26, 2004.

(51) Int. Cl. B65F 1/16; E05C 19/00

(52) U.S. Cl. 108/25; 108/50.11; 108/161

(57) ABSTRACT

A combination support surface and receptacle for catering or special events presentation, the support surface comprising a relatively flat, portable table top having a plurality of legs mounted thereto for supporting the table top, the legs having sufficient length and being arranged suitably for suspending the top in a generally horizontal position over at least one refuse container such that the container comprises a base of the table, the legs being releasably joined to the table top for ready mounting or collapse of the same, wherein each of the legs are releasably joined at one end to the table top by a mounting bracket, one end of at least one of the legs being partially recessed for engagement with and securement to a handle portion of the refuse container, and one end of at least one of the other legs being recessed for sliding engagement with and securement to a rim portion of the refuse container.

### FIELD OF THE INVENTION

The present invention relates generally to support surfaces and, more particularly, to tables for support, events, presentation or the like.

### BACKGROUND OF THE INVENTION

While space and layout for special events and/or catering, especially formal ones, frequently necessitate aesthetically pleasing table surfaces for serving food, displaying items or the like, practicality and convenience dictates that there be ready access to waste disposal receptacles. The result has been a clash of interests. For instance, unsightly waste containers are often positioned about presentation tables and other decorative aspects of special events and/or catered events, thereby detracting from the purpose of the tables. Alternatively, decorative tables and the like are arranged in a relatively aesthetically pleasing manner, with waste disposal receptacles being ignored or placed far away, such as in one or more corners of the room, behind curtains adjacent exits. Hence, either guests and/or spectators are either inconvenienced by having to stop their discussion and look for a place to discard an item, such as a used napkin, obtained from and consumed in front of the table. Or the design of the event, mood, and/or aesthetically pleasing nature of the table and event decorations are disrupted or interfered with by the unsightly but practical necessity of garbage containers.

An arrangement is, therefore, desired that solves event and catering problems where space and event layout necessitate aesthetically pleasing table surfaces combined with ready access to waist disposal receptacles.

### SUMMARY OF THE INVENTION

According to one aspect of the present invention, there is provided a combination support surface and receptacle for catering or special events presentation, the support surface comprising a relatively flat, portable table top having a plurality of legs mounted thereto for supporting the table top, the legs having sufficient length and being arranged suitably for suspending the top in a generally horizontal position over at least one refuse container such that the container comprises a base of the table, the legs being releasably joined to the table top for ready mounting or collapse of the same.

In accordance with another aspect of the present invention, there is provided a combination support surface and receptacle for catering or special events presentation, the support surface comprising a relatively flat, portable table top having a plurality of legs mounted thereto for supporting the table top, the legs having sufficient length and being arranged suitably for suspending the top in a generally horizontal position over at least one refuse container such that the container comprises a base of the table, the legs being releasably joined to the table top for ready mounting or collapse of the same, wherein each of the legs are releasably joined at one end to the table top by a mounting bracket, one end of at least one of the other legs being partially recessed for engagement with and securement to a handle portion of the refuse container, and one end of at least one of the other legs being recessed for sliding engagement with and securement to a rim portion of the refuse container.

According to a further aspect of the present invention, a method is provided for assembly or disassembly of a combination support surface and receptacle for catering or special events presentation, comprising the steps of (i) releasably mounting a plurality of legs to a support surface so as to suspend the surface in a generally horizontal position, the support surface comprising a relatively flat, portable table top and the legs having sufficient length and being arranged suitably for suspending the top in a generally horizontal position; (ii) positioning the releasably mounting legs of the support over at least one refuse container; and (iii) releasably mounting the legs to the container such that the container comprises a base of the table.

It is, therefore, an object of the present invention to provide a catering table eloped that solves event and catering problems where space and event layout necessitate aesthetically pleasing table surfaces and ready access to waste disposal receptacles is needed.

Another object of the present invention is to provide a 2 in 1 support surface for catering and special events that provides aesthetically pleasing support surfaces in combination with ready access to waste disposal containers.

A further object of the present invention is to provide a flat table-like surface that is particularly useful for event planners and coordinators, caterers, municipal authorities, parks facilities, stadiums, auditoriums, restaurants, hotels, and any other entity or individual seeking such a unique combined function design concept.

The present invention will now be further described by reference to the following drawings which are not intended to limit the accompanying claims.

### BRIEF DESCRIPTION OF THE DRAWINGS

FIG. 1 is a perspective view of a portable, collapsible combination support surface and receptacle, according to one aspect of the present invention;

FIG. 2 is a reverse plan view of support surface and legs set forth in FIG. 1;

FIG. 3 is an enlarged view of section A shown in FIG. 2 illustrating a mounting bracket and leg in a releasably secured position;

FIG. 4 is a sectional view of the support surface and receptacle taken along line 3-3 of FIG. 1;

FIG. 5 is an enlarged view of section B shown in FIG. 3;

FIG. 6 is an alterative perspective view of the support surface and receptacle shown in FIG. 1;

FIG. 7 is an alternative perspective view of the support surface and receptacle of FIG. 1 showing substantial portions of the table top;

FIG. 8 is a perspective view of the support surface and legs set forth in FIG. 2;

FIG. 9 is an enlarged view of mounting assemblies of the support surface and first legs shown in FIG. 8;

FIG. 10 is an enlarged view of mounting assemblies of the support surface and second legs shown in FIG. 8;

FIG. 11 is an enlarged view of mounting assemblies of the support surface and third legs shown in FIG. 8; and

FIG. 12 is an enlarged view of mounting assemblies of the support surface and fourth legs shown in FIG. 8.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

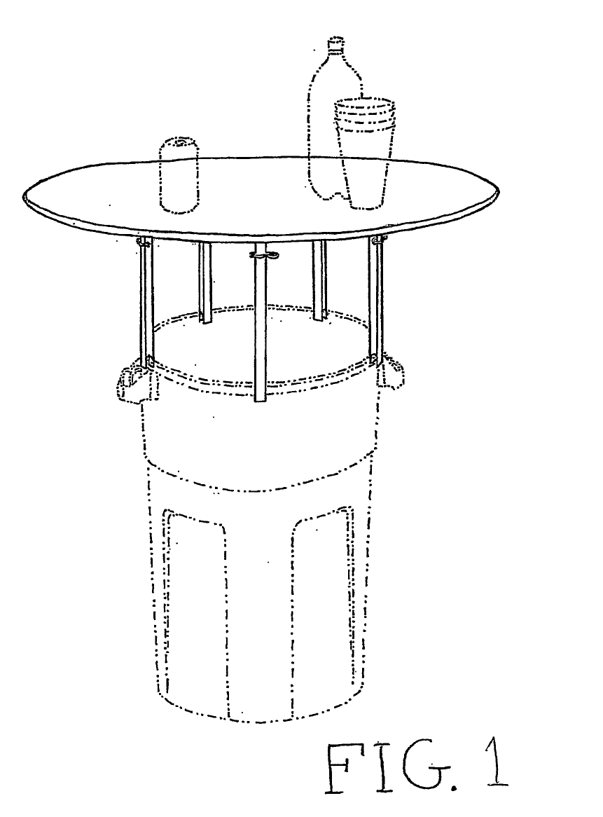

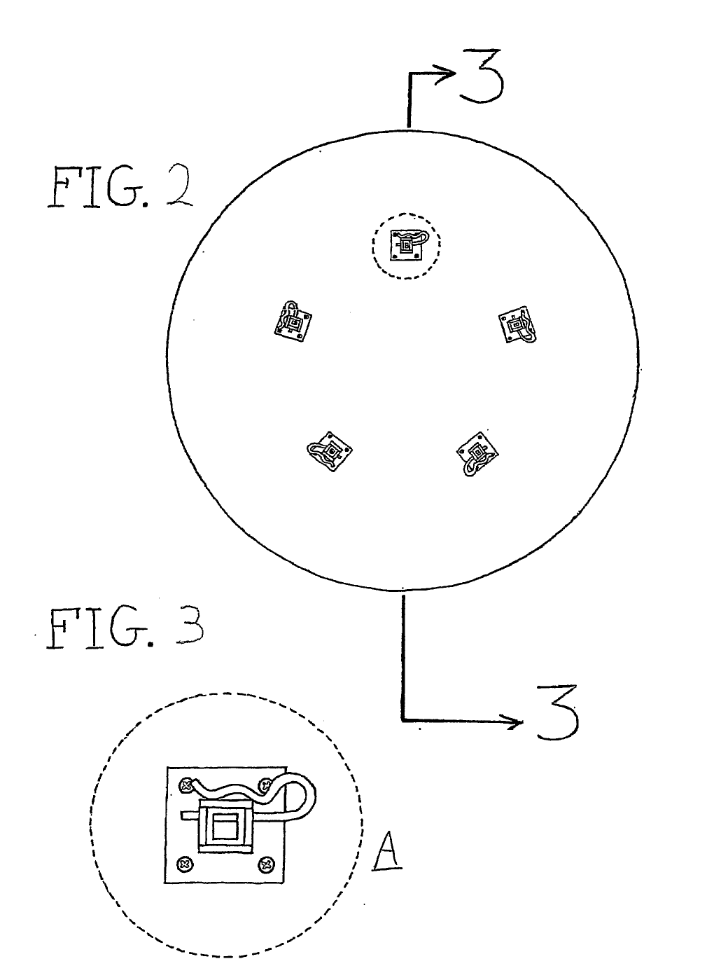

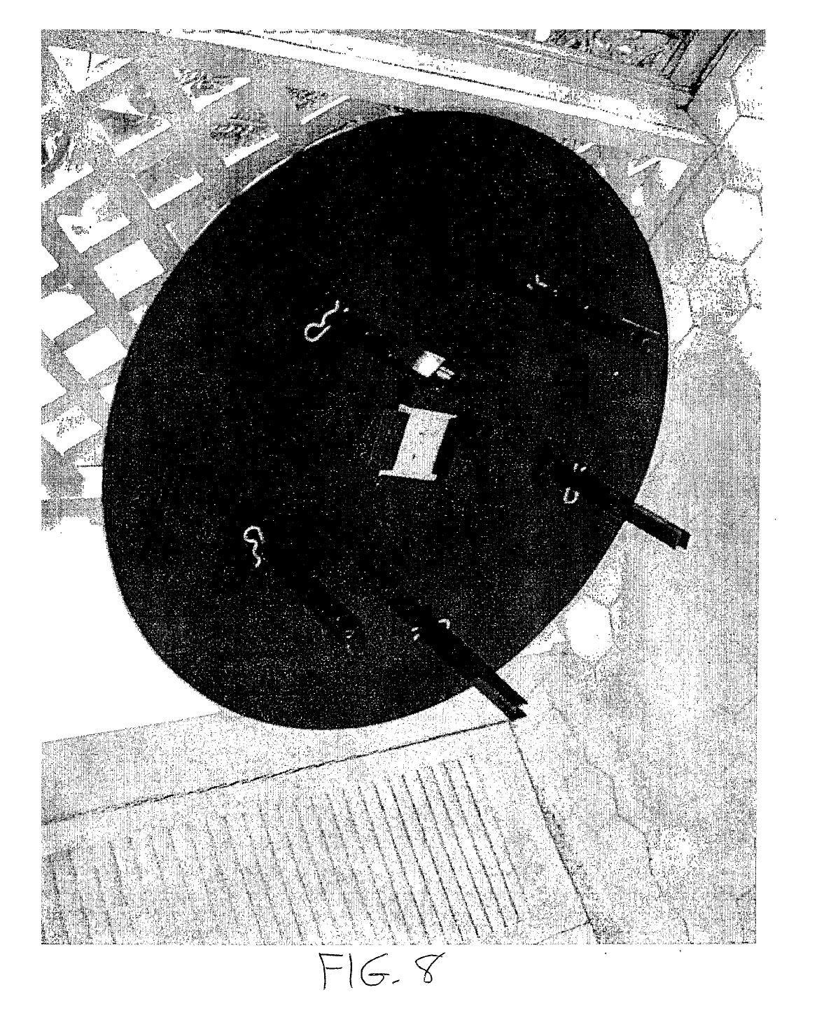

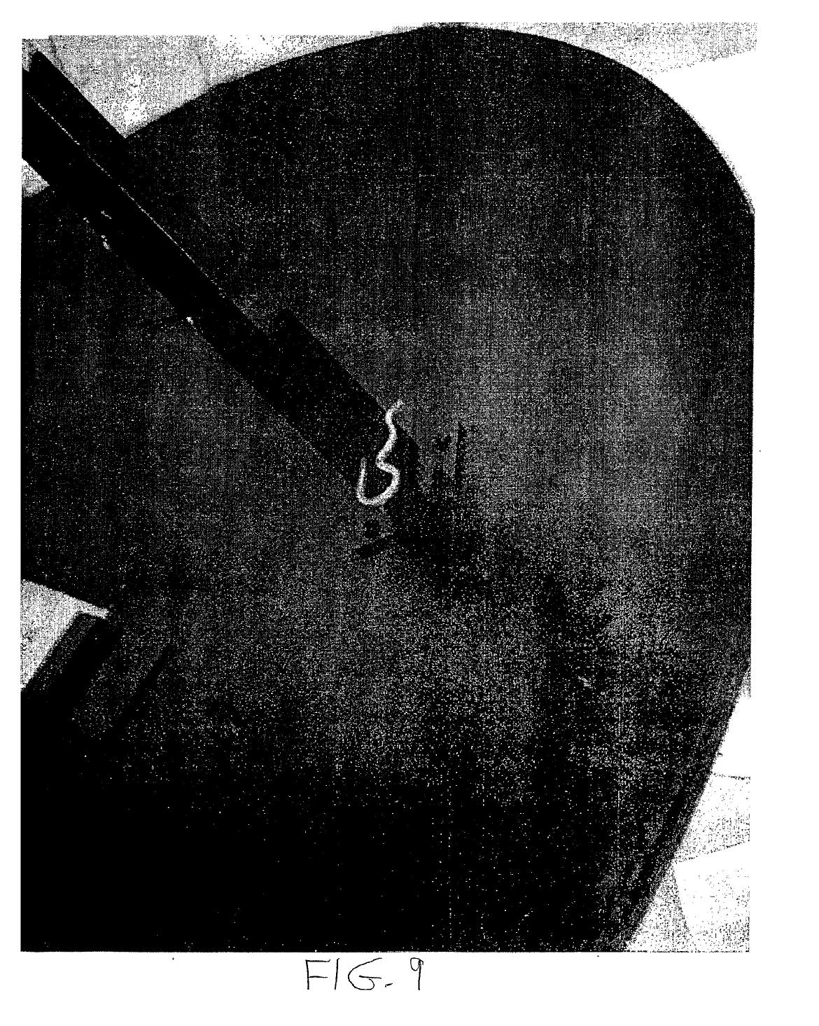

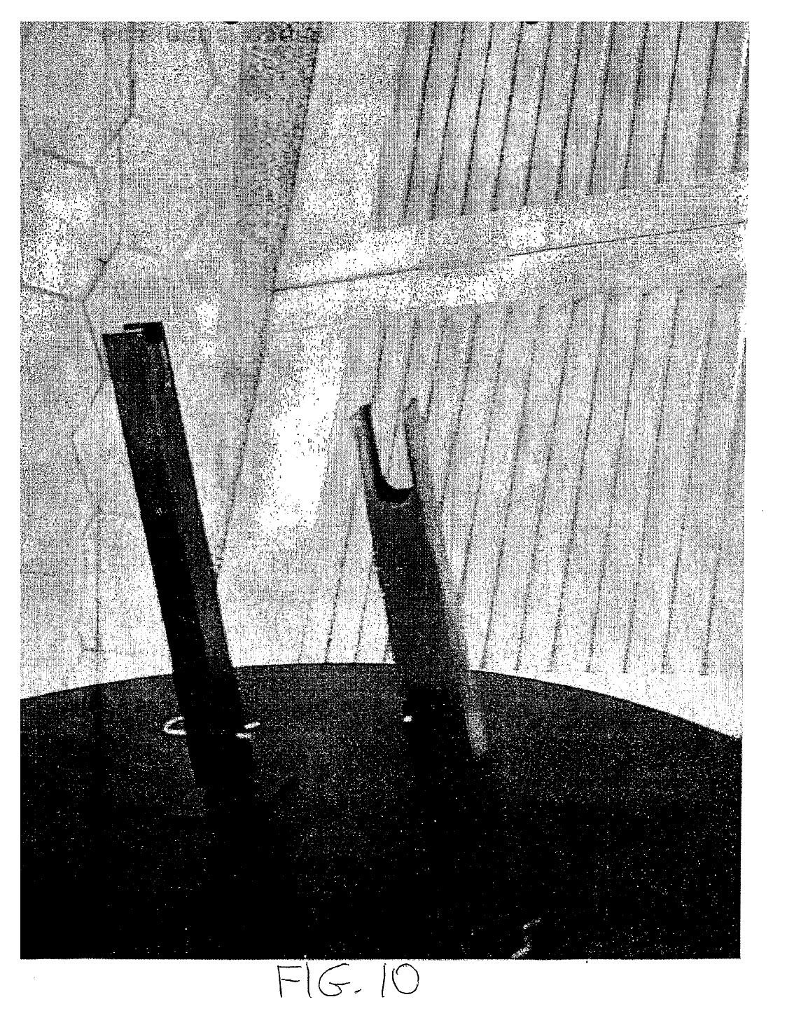

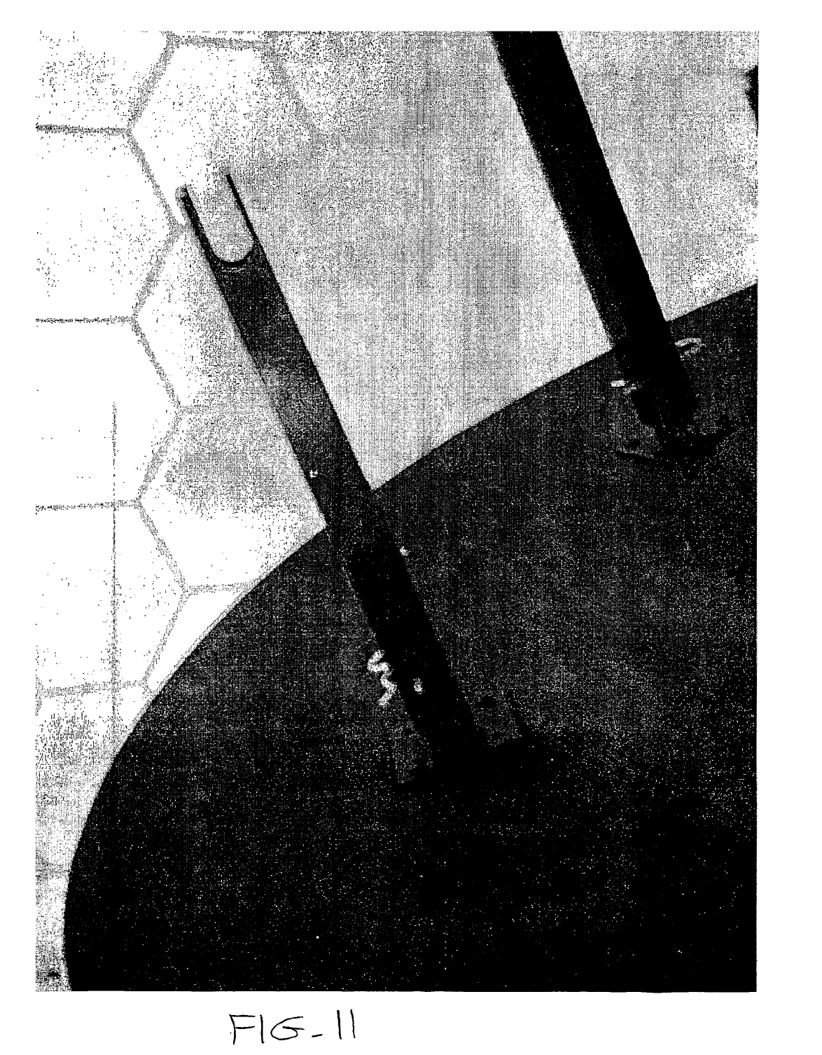

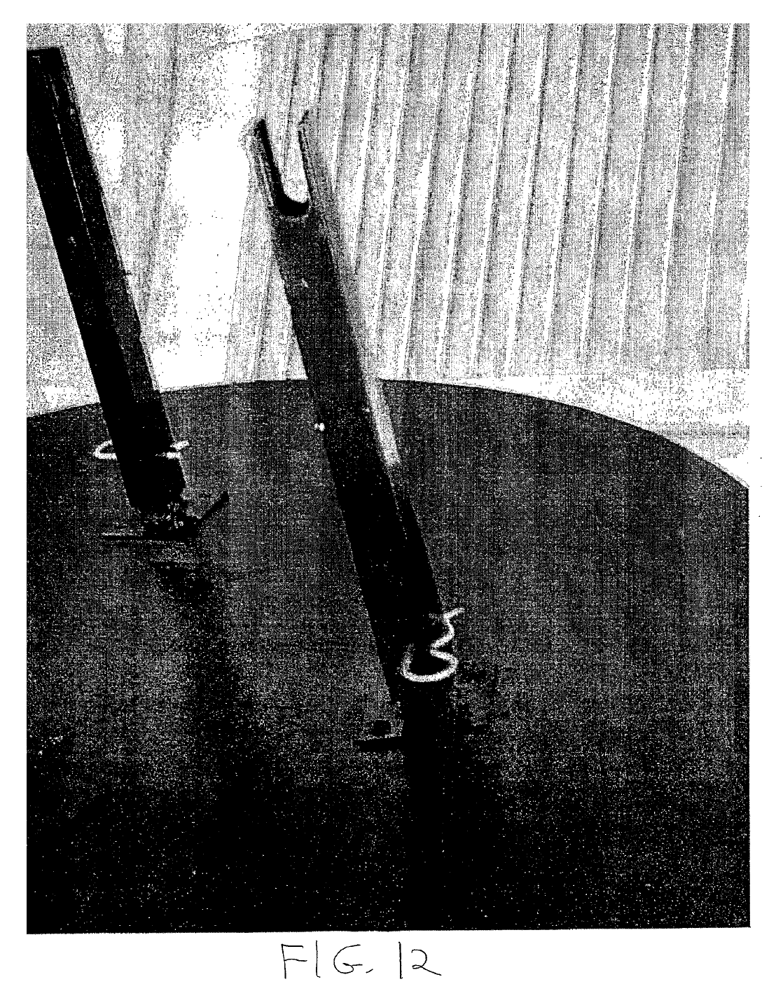

Referring now to the drawings and, more particularly, to FIGS. 1-12, there is shown generally a specific, illustrative support surface, according to various aspects of the present invention. According to one embodiment, a 2 in 1 caterer's table is provided. The table preferably has a portable table top with legs having sufficient length for mounting on any of a number of standard refuse containers, the containers comprising the base of the table.

More specifically, a combination support surface and receptacle is provided for catering or special events presentation. Desirably, the support surface comprises a relatively flat, portable table top having a plurality of legs mounted thereto for supporting the table top. The legs are of sufficient length and are arranged suitably for suspending the top in a generally horizontal position over at least one refuse container, the container thereby comprising a base of the table. The legs are releasably joined to the table top for ready mounting or collapse of the same.

In one embodiment, at least one of the legs, and desirably each of the legs, is releasably joined from one end to the table top using a mounting bracket. The bracket is affixed to an underside portion of the table top in a conventional manner using suitable fasters such as screws, rivets or bolts. The other, opposite end of at least one of the legs, and preferably each of the legs, has a channel or recess formed therein configured appropriately for sliding engagement with a rim of the refuse container, e.g., a conventional Rubbermaid® curb-side style garbage container.

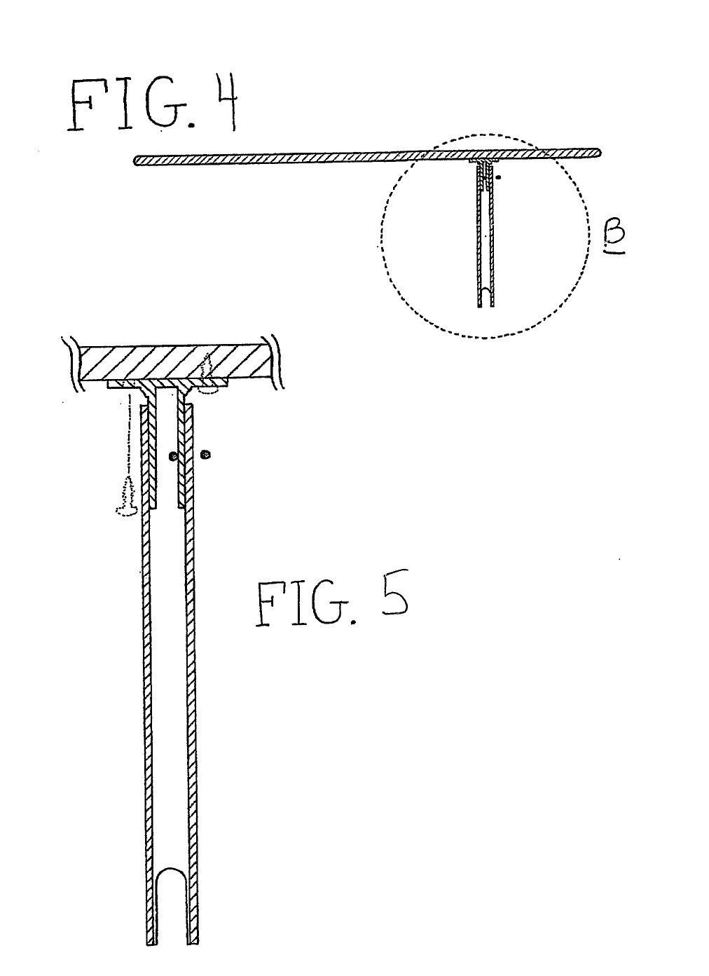

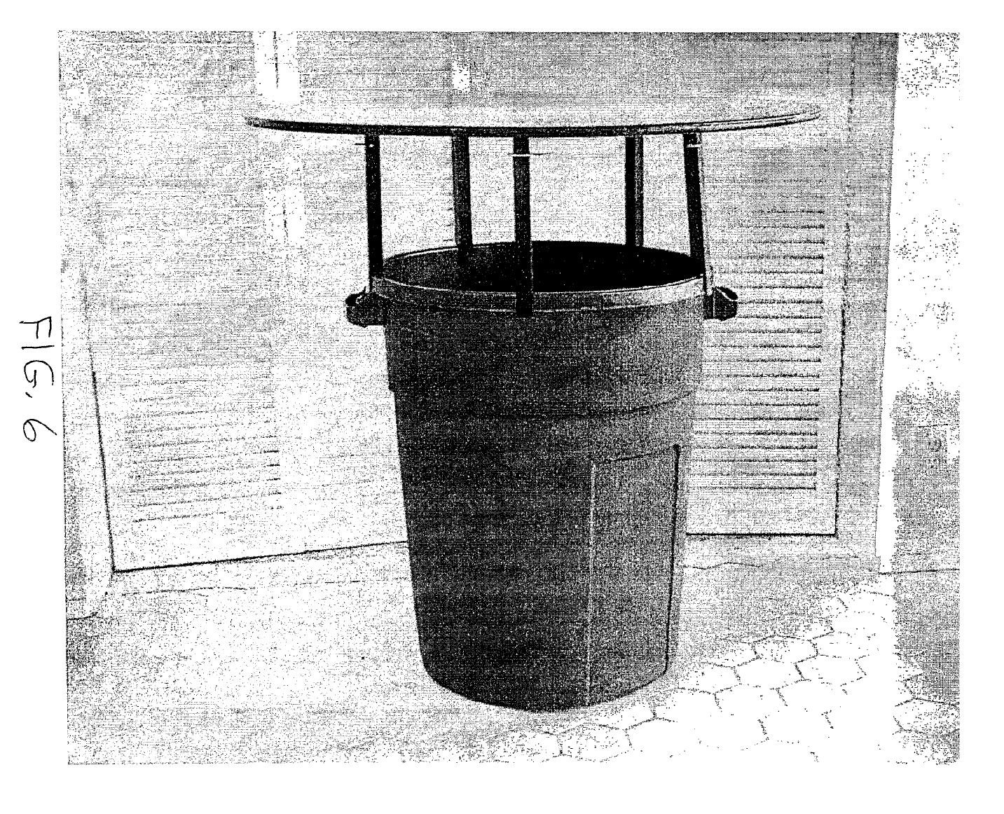

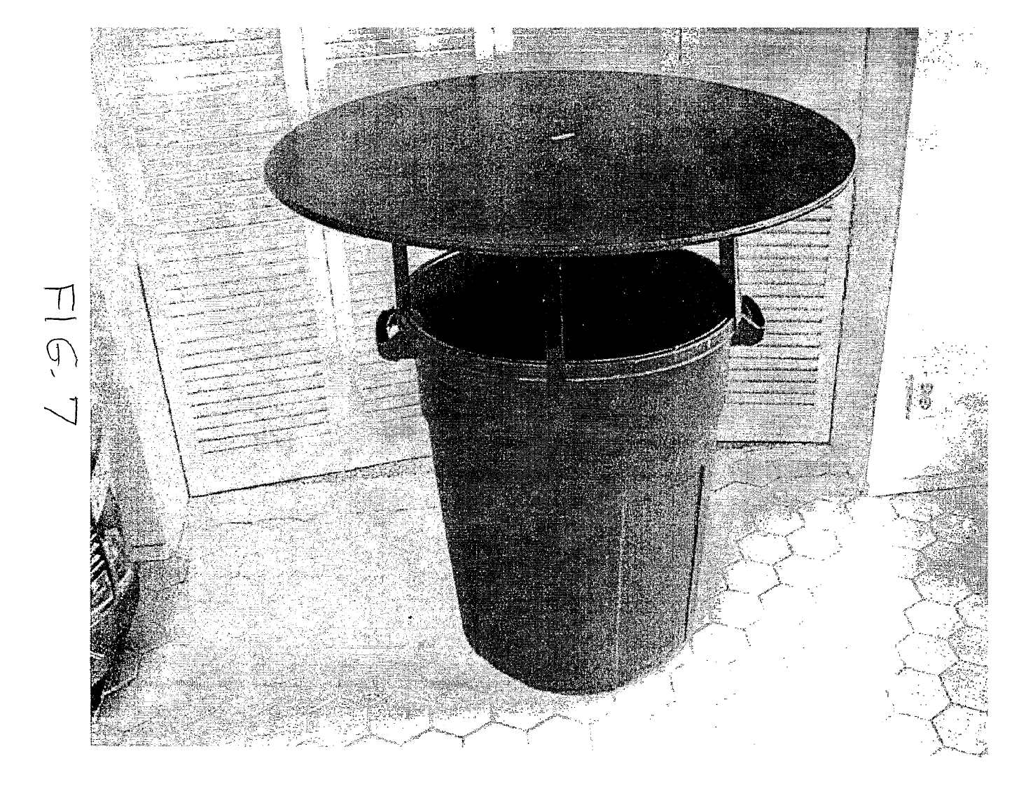

As best seen in FIGS. 4 and 5, the legs are hollowed, sized and shaped for slidingly receiving a correspondingly shaped and sized mating section of the mounting bracket. Upon engagement of the mating section a selected distance into the leg, perforations in the mating section are in alignment with cooperating holes in the leg for receiving a suitable fastener, e.g., a cotter pin, for releasable securement thereto. It is preferred that one or more legs be so configured for releasable attachment of the legs to the table top underside.

The other end of one or more of the legs, e.g., three, are recessed for sliding engagement with and securement to a rim portion of the refuse container. Alternatively or concurrently, the other end of one or more of the legs, e.g., two, are partially recessed for engagement with and securement to a handle portion of the refuse container such as at opposing sides of a conventional trash can.

Another aspect of the present invention relates to a combination support surface and receptacle for catering or special events presentation, the support surface comprising a relatively flat, portable table top having a plurality of legs mounted thereto for supporting the table top, the legs having sufficient length and being arranged suitably for suspending the top in a generally horizontal position over at least one refuse container such that the container comprises a base of the table, the legs being releasably joined to the table top for ready mounting or collapse of the same, wherein each of the legs are releasably joined at one end to the table top by a mounting bracket, one end of at least one of the legs being partially recessed for engagement with and securement to a handle portion of the refuse container, and one end of at least one of the other legs being recessed for sliding engagement with and securement to a rim portion of the refuse container.

Although the present invention is shown and described as being constructed of plywood with metal legs and the drum container being a polymeric material such as that of a conventional plastic, e.g., Rubbermaid® type, trash can or other garbage container, the invention is desirably constructed of a flexible or rigid polymeric material such as PVC or other plastic, or, in whole or in part, using other suitable materials including, but not limited to, an aluminum alloy, titanium, or other suitable metal and/or alloy thereof, and/or a suitable carbon fiber composite or the like.

In addition, while the present invention is shown and described with a table top having a relatively circular shape and a refuse container that is also relatively circular in shape, it is understood that the components of the present invention may take other shapes and configurations, such as generally that of a rectangle, square, trapezoid, diamond or like shapes as well as non-euclidean shapes, within the spirit and scope of the present invention.

Also, it will be appreciated that the shape of the components need not be the same, i.e., the present invention is not limited to the single round arrangement shown—a round table top paired with a round or cylindrical refuse container, but may be in other suitable shapes such as square, rectangular, trapezoidal, diamond or like shapes, as set forth above, and/or contoured shapes for added esthetic appeal. Suitability for construction of irregular and/or customized shapes, including non-euclidean shapes, is also understood, giving consideration to the purpose for which the present invention is intended. Furthermore, as those skilled in the art will appreciate, the present invention may be modified to cover one to many refuse containers and the refuse containers may be of any standard conventional design or size.

Turning now to yet a further aspect of the present invention, a method is provided for assembly of a combination support surface and receptacle for catering or special events presentation. Initially, a plurality of legs are releasably mounted to a support surface so as to suspend the surface in a generally horizontal position, the support surface comprising a relatively flat, portable table top and the legs having sufficient length and being arranged suitably for suspending the top in a generally horizontal position. Next, the releasably mounting legs of the support are positioned over at least one refuse container. The legs are then releasably mounted to the container such that the container comprises a base of the table.

It is preferred that each of the legs be releasably joined at one end to the table top by a mounting bracket, one end of at least one of the legs being partially recessed for engagement with and securement to a handle portion of the refuse container, and one end of at least one of the other legs being recessed for sliding engagement with and securement to a rim portion of the refuse container.

Alternatively or concurrently, a method is provided for disassembling the a combination support surface and receptacle for catering or special events presentation. First, the legs are detached from the table base or container. Second, the legs of the support are removed and, in turn, moved away from the container. Third, each of the plurality of legs is detached from the support surface, thereby providing suitably for collapse of the combination support and receptacle assembly.

Overall, the present invention provides numerous practical advantages. First, in combining one or more table tops with the refuse container(s) as a base, the present invention not only allows for easy and convenient clean-up during and after catering and/or events, but also improves user efficiency. The invention additionally provides heightened serving and cleaning aesthetics. It provides a serving surface as well as a bar, dining, or snacking surface. Moreover, various sized and shaped table tops, fitted to one or more bases, can be configured to meet many standard catering needs while streamlining or reducing space and equipment requirements.

The 2 in 1 table advantageously provides a table and leg arrangement mounted on standard refuse containers so as to create a flat table like surface that is particularly useful for event planners and coordinators, caterers, municipal authorities, parks facilities, stadiums, auditoriums, restaurants, hotels, and any other entity or individual seeking such a unique combined function design concept.

Various modifications and alterations to the present invention may be appreciated based on a review of this disclosure. These changes and additions are intended to be within the scope and spirit of this invention as defined by the following claims.

What is claimed is:

1. A combination support surface and receptacle for catering or special events presentation, the support surface comprising a relatively flat, portable table top having a plurality of legs mounted thereto for supporting the table top, the legs having sufficient length and being arranged suitably for suspending the top in a generally horizontal position over at least one refuse container such that the container comprises a base of the table, the legs being releasably joined to the table top for ready mounting or collapse of the same.

2. The support surface and receptacle set forth in claim 1, wherein the table top is relatively circular in shape.

3. The support surface and receptacle set forth in claim 1, wherein the table top is generally rectangular in shape.

4. The support surface and receptacle set forth in claim 1, wherein the refuse container is constructed of a polymeric material.

5. The support and receptacle set forth in claim 1, wherein the refuse container is a conventional plastic trash can.

6. The support and receptacle set forth in claim 1, wherein the refuse container is relatively circular in shape.

7. The support and receptacle set forth in claim 1, wherein the refuse container is generally rectangular in shape.

8. The support and receptacle set forth in claim 1, wherein at least one of the legs is releasably joined to the table top by a cotter pin.

9. The support and receptacle set forth in claim 1, wherein at least one of the legs is releasably joined at one end to the table top by a mounting bracket, the other end of the leg being recessed for sliding engagement with and securement to a rim of the refuse container.

10. The support and receptacle set forth in claim 1, wherein each leg is releasably joined at one end to the table top by a mounting bracket, the other end of each leg being recessed for sliding engagement with and securement to a rim portion of the refuse container.

11. The support and receptacle set forth in claim 1, wherein at least two of the legs are releasably joined at one end to the table top by a mounting bracket, the other end of the legs being recessed for sliding engagement with and securement to a rim portion of the refuse container.

12. The support and receptacle set forth in claim 1, wherein at least one of the legs are releasably joined at one end to the table top by a mounting bracket, the other end of the legs being partially recessed for engagement with and securement to a handle portion of the refuse container.

13. The support and receptacle set forth in claim 1, wherein each of the legs are releasably joined at one end to the table top by a mounting bracket, one end of at least one of the legs being partially recessed for engagement with and securement to a handle portion of the refuse container, and one end of at least one of the other legs being recessed for sliding engagement with and securement to a rim portion of the refuse container.

14. A combination support surface and receptacle for catering or special events presentation, the support surface comprising a relatively flat, portable table top having a plurality of legs mounted thereto for supporting the table top, the legs having sufficient length and being arranged suitably for suspending the top in a generally horizontal position over at least one refuse container such that the container comprises a base of the table, the legs being releasably joined to the table top for ready mounting or collapse of the same, wherein each of the legs are releasably joined at one end to the table top by a mounting bracket, one end of at least one of the legs being partially recessed for engagement with and securement to a handle portion of the refuse container, and one end of at least one of the other legs being recessed for sliding engagement with and securement to a rim portion of the refuse container.

15. A method for assembly or disassembly of a combination support surface and receptacle for catering or special events presentation, comprising the steps of:
(i) releasably mounting a plurality of legs to a support surface so as to suspend the surface in a generally horizontal position, the support surface comprising a relatively flat, portable table top and the legs having sufficient length and being arranged suitably for suspending the top in a generally horizontal position;
(ii) positioning the releasably mounting legs of the support over at least one refuse container; and
(iii) releasably mounting the legs to the container such that the container comprises a base of the table.

15. The method set forth in claim 14, wherein each of the legs are releasably joined at one end to the table top by a mounting bracket, one end of at least one of the legs being partially recessed for engagement with and securement to a handle portion of the refuse container, and one end of at least one of the other legs being recessed for sliding engagement with and securement to a rim portion of the refuse container.

16. The method set forth in claim 14, further comprising the steps of (iv) detaching the legs from the table base or container, (v) removing the legs of the support and moving them away from the container, and (vi) detaching the plurality of legs from the support surface for collapse of the combination support and receptacle.
